(19) United States
(12) Patent Application Publication
(10) Pub. No.: US 2023/0418890 A1
(43) Pub. Date: Dec. 28, 2023

(54) CONTENT SCREENING METHOD AND DEVICE

(71) Applicant: SHANGHAI BILIBILI TECHNOLOGY CO., LTD., Shanghai (CN)

(72) Inventors: Junhao WU, Shanghai (CN); Qizhen HE, Shanghai (CN)

(21) Appl. No.: 18/024,485

(22) PCT Filed: Jun. 30, 2021
(86) PCT No.: PCT/CN2021/103571

§ 371 Date: Mar. 2, 2023

(30) Foreign Application Priority Data
Sep. 4, 2020 (CN) 202010920038.6

(51) Int. Cl. G06F 16/954

(52) U.S. Cl. CPC G06F 16/954

(57) ABSTRACT

Techniques provided comprises obtaining a content set to be screened, wherein the content set comprises a plurality of to-be-screened contents, wherein each to-be-screened content is associated with identification information, at least one tag indicative of at least one category, and a score; computing a distribution quota value of each category indicated by a corresponding tag and associated with the plurality of to-be-screened contents based on the at least one category and a weight value corresponding to the at least one category; computing a target distribution quota value of the tag of each category based on the distribution quota value of each category and a preset tag distribution quota adjustment function; and sequentially selecting target contents from the content set based on the target distribution quota value of each category and the weight value corresponding to the at least one category associated with each to-be-screened content.

This application claims priority to Chinese Patent Application No. 202010920038.6, filed with the China National Intellectual Property Administration on Sep. 4, 2020, and entitled “CONTENT SCREENING METHOD AND APPARATUS”, which is incorporated herein by reference in its entirety.

### TECHNICAL FIELD

This application relates to the field of computer technologies, and in particular, to a content screening method and apparatus.

### BACKGROUND

In recommendation systems of various different scenarios, it is usually necessary to go through processes such as user portrait querying, recommended content retrieval recalling, and multi-round sorting and screening. After a large quantity of recommended contents are recalled from a recommended content library, before several recommended contents are selected and finally recommended to a user, a middle sorting and screening process is usually performed by using a preset screening rule. However, the inventor finds that, in the conventional technology, when recommended content screening is performed by using the preset screening rule, it is usually necessary to perform nested traversal processing for each to-be-screened content. Consequently, a target recommended content can be selected only after a large amount of computing resources and a relatively large amount of time are consumed in the screening process.

### SUMMARY

In view of this, this application provides a content screening method and apparatus, a computer device, and a computer-readable storage medium, to resolve a problem, in the conventional technology, that a large amount of computing resources need to be consumed and a relatively large amount of time is needed during recommended content screening. This application provides a content screening method, including:
obtaining a to-be-screened content set, where the content set includes a plurality of to-be-screened contents, each to-be-screened content has identification information, a tag of at least one category, and a score, and the plurality of to-be-screened contents are sorted by scores in the content set in advance;
calculating, based on a tag of each category in each to-be-screened content and a weight value corresponding to the tag of each category, a distribution quota value of a tag that is of each category and that is included in the content set;
calculating a target distribution quota value of the tag of each category based on each distribution quota value and a preset tag distribution quota adjustment function; and
sequentially selecting target contents that meet a first preset condition from the content set based on the target distribution quota value of the tag of each category and the weight value corresponding to the tag of each category in each to-be-screened content.

Optionally, the calculating, based on a tag of each category in each to-be-screened content and a weight value corresponding to the tag of each category, a distribution quota value of a tag that is of each category and that is included in the content set includes:
obtaining a weight value of a tag of a current category in each to-be-screened content, where the tag of the current category is a tag of a category in tags that are of all categories and that are included in the content set; and
using a sum of all obtained weight values as a distribution quota value of the tag of the current category.

Optionally, the sequentially selecting target contents that meet a first preset condition from the content set based on the target distribution quota value of the tag of each category and the weight value corresponding to the tag of each category in each to-be-screened content includes:
performing a screening operation on the to-be-screened contents according to sorting of the to-be-screened contents in the content set, where the screening operation includes:
obtaining a first weight value corresponding to a tag of each category in a current to-be-screened content;
determining whether a first target distribution quota value corresponding to the tag of the category in the current to-be-screened content is greater than or equal to the first weight value; and
if yes, using the current to-be-screened content as a target content, and updating the first target distribution quota value to a difference between the first target distribution quota value and the first weight value.

Optionally, the content screening method further includes:
when a quantity of selected target contents is less than a preset quantity, selecting a target content that meets a second preset condition from remaining to-be-screened contents in the content set, where the second preset condition is that a target distribution quota value corresponding to a tag of at least one category in a current to-be-screened content is not 0.

Optionally, the content screening method further includes:
when a quantity of selected target contents is less than a preset quantity, selecting a target content that meets a third preset condition from remaining to-be-screened contents in the content set, where the third preset condition is that a current to-be-screened content has a preset mark.

Optionally, the content screening method further includes:
when a quantity of selected target contents is less than a preset quantity, selecting a target content that meets a fourth preset condition from remaining to-be-screened contents in the content set, where the fourth preset condition is that a score of a current to-be-screened content is greater than scores of other to-be-screened contents.

Optionally, before the step of calculating, based on a tag of each category in each to-be-screened content and a weight value corresponding to the tag of each category, a distribution quota value of a tag that is of each category and that is included in the content set, the content screening method further includes:
calculating the weight value corresponding to the tag of each category in each to-be-screened content.

This application further provides a content screening apparatus, including:
an obtaining module, configured to obtain a to-be-screened content set, where the content set includes a plurality of to-be-screened contents, each to-be-screened content has identification information, a tag of at least one category, and a score, and the plurality of to-be-screened contents are sorted by scores in the content set in advance;
a first calculation module, configured to calculate, based on a tag of each category in each to- be-screened content and a weight value corresponding to the tag of each category, a distribution quota value of a tag that is of each category and that is included in the content set;
a second calculation module, configured to calculate a target distribution quota value of the tag of each category based on each distribution quota value and a preset tag distribution quota adjustment function; and
a screening module, configured to sequentially select target contents that meet a first preset condition from the content set based on the target distribution quota value of the tag of each category and the weight value corresponding to the tag of each category in each to-be-screened content.

This application further provides a computer device, where the computer device includes a memory, a processor, and computer-readable instructions that are stored in the memory and that can run on the processor, where the processor implements the following steps when executing the computer-readable instructions:
obtaining a to-be-screened content set, where the content set includes a plurality of to-be-screened contents, each to-be-screened content has identification information, a tag of at least one category, and a score, and the plurality of to-be-screened contents are sorted by scores in the content set in advance;
calculating, based on a tag of each category in each to-be-screened content and a weight value corresponding to the tag of each category, a distribution quota value of a tag that is of each category and that is included in the content set;
calculating a target distribution quota value of the tag of each category based on each distribution quota value and a preset tag distribution quota adjustment function; and
sequentially selecting target contents that meet a first preset condition from the content set based on the target distribution quota value of the tag of each category and the weight value corresponding to the tag of each category in each to-be-screened content.

This application further provides a computer-readable storage medium, where the computer-readable storage medium stores computer-readable instructions, and the following steps are implemented when the computer-readable instructions are executed by a processor:
obtaining a to-be-screened content set, where the content set includes a plurality of to-be-screened contents, each to-be-screened content has identification information, a tag of at least one category, and a score, and the plurality of to-be-screened contents are sorted by scores in the content set in advance;
calculating, based on a tag of each category in each to-be-screened content and a weight value corresponding to the tag of each category, a distribution quota value of a tag that is of each category and that is included in the content set;
calculating a target distribution quota value of the tag of each category based on each distribution quota value and a preset tag distribution quota adjustment function; and
sequentially selecting target contents that meet a first preset condition from the content set based on the target distribution quota value of the tag of each category and the weight value corresponding to the tag of each category in each to-be-screened content.

In the embodiments of this application, the to-be-screened content set is obtained, where the content set includes the plurality of to-be-screened contents, each to-be-screened content has the identification information, the tag of the at least one category, and the score, and the plurality of to-be-screened contents are sorted in the content set in advance by using the scores; the distribution quota value of the tag that is of each category and that is included in the content set is calculated based on the tag of each category in each to-be-screened content and the weight value corresponding to the tag of each category; the target distribution quota value of the tag of each category is calculated based on each distribution quota value and the preset tag distribution quota adjustment function; and the target contents that meet the first preset condition are sequentially selected from the content set based on the target distribution quota value of the tag of each category and the weight value corresponding to the tag of each category in each to-be-screened content. In the embodiments of this application, when the contents in the to-be-screened content set are screened, for each to-be-screened content, it can be determined whether the current to-be-screened content is a target content by performing one time of traversal screening without needing to perform nested traversal. Therefore, this application can save a computing resource that needs to be consumed when the to-be-screened contents are screened, and can reduce time consumed when the to-be-screened contents are screened.

### BRIEF DESCRIPTION OF DRAWINGS

FIG. 1 is a schematic diagram of screening to-be-screened contents according to an embodiment of this application;

FIG. 2 is a flowchart of an embodiment of a content screening method according to this application;

FIG. 3 is a detailed flowchart of a step of calculating, based on a tag of each category in each to-be-screened content and a weight value corresponding to the tag of each category, a distribution quota value of a tag that is of each category and that is included in a content set;

FIG. 4 shows a quota value change status that is of a tag of each category and that is obtained after a target distribution quota value of the tag of each category is processed by using a tag distribution quota adjustment function in this application;

FIG. 5 is a program module diagram of an embodiment of a content screening apparatus according to this application; and

FIG. 6 is a schematic diagram of a hardware structure of a computer device performing a content screening method according to an embodiment of this application.

### DESCRIPTION OF EMBODIMENTS

The following further describes the advantages of this application with reference to the accompanying drawings and specific embodiments.

Example embodiments are described in detail herein, and examples of the embodiments are shown in the accompanying drawings. When the following description involves the accompanying drawings, unless otherwise specified, same numbers in different accompanying drawings represent same or similar elements. The implementations described in the following example embodiments do not represent all implementations consistent with this disclosure. On the contrary, they are only examples of an apparatus and a method that are detailed in the appended claims and consistent with some aspects of this disclosure.

The terms used in this disclosure are merely used to describe specific embodiments, but are not intended to limit this disclosure. The singular forms “one”, “the”, and “this” used in this disclosure and the appended claims are also intended to cover plural forms, unless otherwise specified in the context clearly. It should be further understood that the term “and/or” used in this specification indicates and includes any or all possible combinations of one or more associated listed items.

It should be understood that, although terms such as first, second, and third may be used in this disclosure to describe various types of information, these pieces of information shall not be limited to these terms. These terms are only used to distinguish between information of a same type. For example, without departing from the scope of this disclosure, first information may also be referred to as second information. Similarly, the second information may also be referred to as the first information. Depending on the context, for example, the word “if” used herein can be explained as “while”, “when”, or “in response to determining”.

In the description of this application, it should be understood that number signs used before steps do not indicate a sequence of performing the steps, and are only used to facilitate description of this application and distinguish between all the steps, and therefore cannot be construed as a limitation to this application.

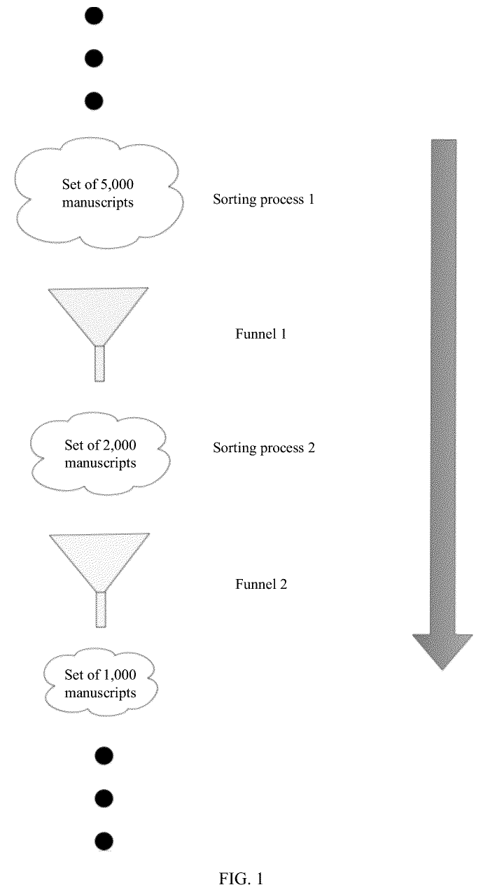

FIG. 1 is a schematic diagram of screening to-be-screened contents according to an embodiment of this application. In an example embodiment, a set of 5,000 manuscripts are recalled from a to-be-recommended content library (manuscript library) after operations such as querying, matching, and sorting are performed based on a user portrait. After the set of 5,000 manuscripts is obtained, a set of 2,000 manuscripts is obtained after first-time screening and sorting is performed by using a first preset screening rule. Then, a set of 1,000 manuscripts is obtained after second-time screening and sorting is performed by using a second preset screening rule. Finally, a final recommended content can be obtained after several rounds of screening and sorting and recommended to a user. Each round of manuscript set screening is like manuscript set selection and filtering performed by using a funnel, and a screening rule is equivalent to setting a funnel filtering port of a specific size for the funnel.

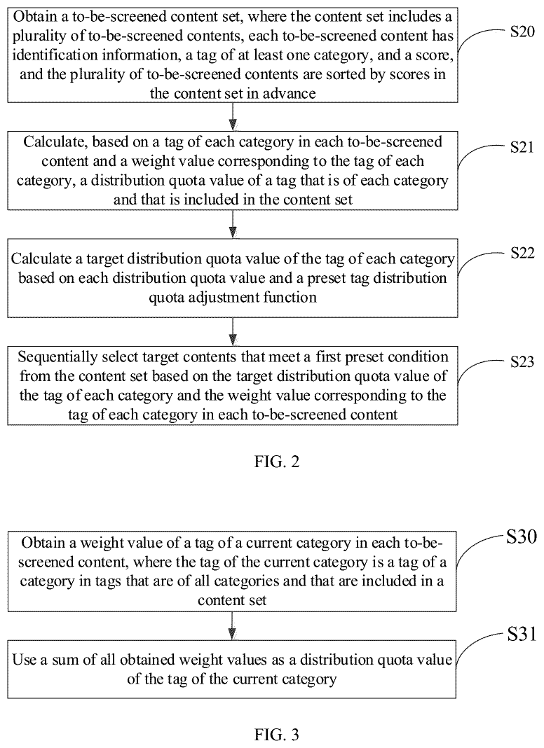

FIG. 2 is a schematic flowchart of a content screening method according to an embodiment of this application. The content screening method of this application may be applied to a content screening process of each funnel in FIG. 1. It can be understood that the flowchart in this method embodiment is not intended to limit a sequence of performing steps. The following uses a computer device as an execution body for example description. It can be learned from the figure that, the content screening method provided in this embodiment includes the following steps:

Step S20: Obtain a to-be-screened content set, where the content set includes a plurality of to-be-screened contents, each to-be-screened content has identification information, a tag of at least one category, and a score, and the plurality of to-be-screened contents are sorted by scores in the content set in advance.

Specifically, the content set may be contents recalled from a content library based on a user portrait and content features. The recalling indicates a process of retrieving a large amount of contents with specific correlation degrees from the content library in an online service of a recommendation system. This process uses relatively small quantities of users and content features and has a high response speed. The content set may be alternatively to-be-screened contents obtained after one or more times of screening are performed on recalled contents.

The plurality of to-be-screened contents included in the content set are different in different recommendation scenarios. For example, in an audio recommendation scenario/a video recommendation scenario, the content set includes a plurality of to-be-screened audio/video files; in a news recommendation scenario, the content set includes a plurality of to-be-screened news articles; or in a commodity recommendation scenario, the content set includes a plurality of to-be-screened commodities.

It should be noted that, to facilitate description of this application, in this embodiment and the following embodiments, the to-be-screened content is described by using a to-be-screened video manuscript as an example. The video manuscript is a video file uploaded to a platform by a user.

In this embodiment, each obtained to-be-screened video manuscript has identification information, a tag of at least one category, and a score.

The identification information is ID (identity number) information for uniquely distinguishing between different video manuscripts, and different video manuscripts have different IDs.

Each to-be-screened video manuscript has tags of one or more categories, and different to-be-screened video manuscripts may have a same tag category or different tag categories. In addition, different video manuscripts may have a same quantity or different quantities of tags. For example, a video manuscript 1 has tags tag_0 and tag_1, a video manuscript 2 has tags tag_2 and tag_3, and a video manuscript 3 has tags tag_0 and tag_2.

The score is obtained by using a scoring model, and is used to indicate correlation between the to-be-screened video manuscript and a to-be-recommended user. Usually, a higher score value indicates higher correlation between the to-be-screened video manuscript and the to-be-recommended user, and a lower score value indicates lower correlation between the to-be-screened video manuscript and the to-be-recommended user.

In this embodiment, to facilitate subsequent screening of the plurality of to-be-screened video manuscripts in the content set, the plurality of to-be-screened video manuscripts in the content set may be sorted by scores in advance, for example, sorted in descending order of the scores. In this way, when the content set is obtained, the plurality of to-be-screened video manuscripts obtained after sorting is performed in descending order of the scores can be obtained.

Step S21: Calculate, based on a tag of each category in each to-be-screened content and a weight value corresponding to the tag of each category, a distribution quota value of a tag that is of each category and that is included in the content set.

Specifically, each to-be-screened video manuscript has tags of one or more categories, and a total tag weight value (1) is assigned to tags of all categories in each to-be-screened video manuscript, that is, a sum of weight values of the tags of all the categories in each to-be-screened video manuscript is equal to 1. Herein, the weight value 1 is merely an example, and the sum of the weight values of the tags of all the categories in each to-be-screened video manuscript may be another value, provided that the sum of the weight values of the tags of all the categories in the to-be-screened video manuscript is equal to a total weight value of the video manuscript.

The distribution quota value (hereinafter referred to as a “quota value”) is a distribution quota status that is of a tag of each category and that is obtained after component decomposition is performed on the plurality of to-be-screened video manuscripts in the content set based on tag categories. The distribution quota status of the tag may be a sum of all weight values assigned to a tag of a current category.

It should be noted that, in this embodiment, a manner of calculating the distribution quota value of the tag of each category may be considered as a process of performing component decomposition on tags in the plurality of to-be-screened video manuscripts to obtain a component decomposition result.

For example, referring to FIG. 3, the calculating, based on a tag of each category in each to-be-screened content and a weight value corresponding to the tag of each category, a distribution quota value of a tag that is of each category and that is included in the content set includes the following steps:

Step S30: Obtain a weight value of a tag of a current category in each to-be-screened content, where the tag of the current category is a tag of a category in tags that are of all categories and that are included in the content set.

Step S31: Use a sum of all obtained weight values as a distribution quota value of the tag of the current category.

Specifically, when distribution quota values of tags of all categories are calculated, for the distribution quota value of the tag of each category, a weight value of the tag of the current category in each to-be-screened content may be first obtained, and then a sum of all obtained weight values may be used as a distribution quota value of the tag of the current category.

For example, the tag of the current category is a tag a, a video manuscript A, a video manuscript B, and a video manuscript C have the tag a in the content set, and weight values of the tag a in the video manuscript A, the video manuscript B, and the video manuscript C are respectively 0.4, 0.6, and 0.8. In this case, a distribution quota value of the tag a is equal to Similarly, for tags of other categories, distribution quota values of the tags of the other categories may be calculated by using methods similar to the foregoing method.

In this embodiment, the sum of all the obtained weight values is used as the distribution quota value of the tag of the current category, so that the distribution quota value of the tag of each category can be conveniently and quickly obtained.

It can be understood that, when a tag of at least one category in the to-be-screened content carries a weight value corresponding to the tag, to calculate, based on the tag of each category in each to-be-screened content and the weight value corresponding to the tag of each category, the distribution quota value of the tag that is of each category and that is included in the content set, it is necessary to first calculate the weight value corresponding to the tag of each category in the to-be-screened content.

In an implementation, when a weight value corresponding to a tag of each category in the to-be-screened video manuscript is calculated, calculation may be performed according to a preset weight assignment rule. For example, the preset weight assignment rule is equally dividing a total weight 1 of the to-be-screened video manuscript among all tags of all categories in the to-be-screened screened video manuscript. In this case, for a video manuscript A having a tag a and a tag b, it can be learned through calculation that a weight value corresponding to the tag a in the video manuscript A is ½=0.5, and it can be learned through calculation that a weight value corresponding to the tag b in the video manuscript A is ½=0.5. Similarly, for a video manuscript B having the tag a and a tag c, it can be learned through calculation that a weight value corresponding to the tag a in the video manuscript B is ½=0.5, and it can be learned through calculation that a weight value corresponding to the tag c in the video manuscript B is ½=0.5.

In another implementation, when a weight value corresponding to a tag of each category in the to-be-screened video manuscript is calculated, the weight value corresponding to the tag of each category may be calculated through analysis based on a content of the video manuscript. For example, a video manuscript A has two tags: “funny” and “music”. After the video manuscript A is analyzed, it is found that funny elements of the video manuscript A account for 80%, while music elements account for only 20%. In this case, after the video manuscript A is analyzed, it can be learned through calculation that a weight value corresponding to the “funny” tag is 0.8, and a weight value corresponding to the “music” tag accounts for 0.2.

Step S22: Calculate a target distribution quota value of the tag of each category based on each distribution quota value and a preset tag distribution quota adjustment function.

Specifically, different tag distribution quota adjustment functions may be set based on different service scenarios. When a function is specifically set, at least one of the following objectives shall prevail:

Objective 1: A sum of target quota values that are of the tags of all the categories and that are obtained after processing is performed by using the tag distribution quota adjustment function is N, where N is a quantity of target contents selected from the content set.

Objective 2: As many tag categories as possible appear after processing is performed by using the tag distribution quota adjustment function.

Objective 3: Quota ratios of tags of different categories in target quota values obtained after processing is performed by using the tag distribution quota adjustment function are as close as possible to those in the original content set.

Objective 4: Based on a specific application scenario, fine processing with different tendencies is selected, for example, quota values of all the tags may be reconciled to be close to an average value, or a tag whose quota value is too high may be selected for peak clipping, where a reduced quota value obtained in the peak clipping manner can enter a free quota pool.

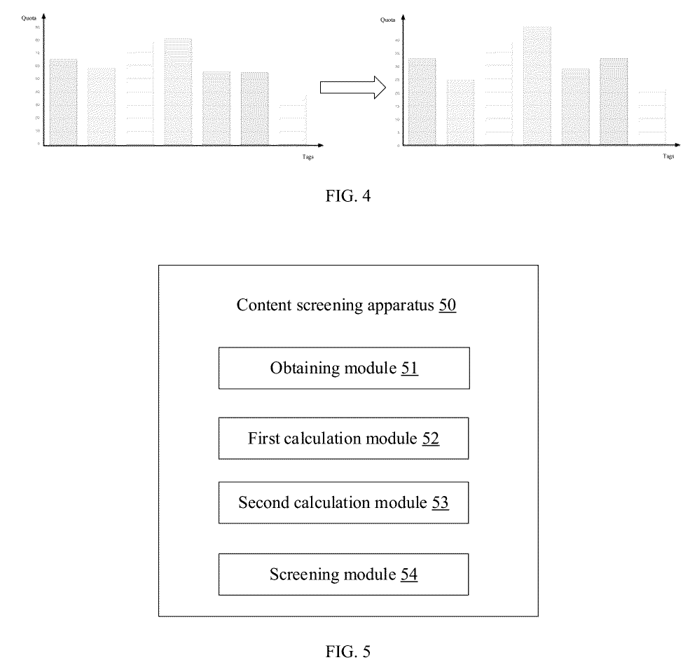

In a specific scenario, the tag distribution quota adjustment function is correspondingly reducing quota values of all the tags by two times, and a quota value change status that is of the tag of each category and that is obtained after processing is performed by using the function is shown in FIG. 4.

Step S23: Sequentially select target contents that meet a first preset condition from the content set based on the target distribution quota value of the tag of each category and the weight value corresponding to the tag of each category in each to-be-screened content.

Specifically, the first preset condition is that tags of all categories in the to-be-screened video manuscript have enough quota values. In this embodiment, when the target contents that meet the first preset condition are selected from the content set based on the target distribution quota value (target quota value) of the tag of each category and the weight value corresponding to the tag of each category in the to-be-screened video manuscript, selection determining may be performed on the to-be-screened video manuscripts based on sorting of the to-be-screened video manuscripts in the content set; and if all tags of all categories in the to-be-screened video manuscript have enough quota values, the to-be-screened video manuscript may be selected from the content set as a target content. After selection determining of a current to-be-screened video manuscript is completed, a next video manuscript is obtained through traversal, and then selection determining is performed on the video manuscript. A screening process is ended until all the video manuscripts are traversed and selection determining is completed, or a video manuscript screening process is stopped until a preset quantity of target contents are selected. The preset quantity is a quantity of target contents that need to be selected from the content library in advance.

It should be noted that the manner of selecting the target contents in this embodiment may be considered as a process of performing composition decomposition on the tags of all the categories and then performing tag recombination.

In an example implementation, the sequentially selecting target contents that meet a first preset condition from the content set based on the target distribution quota value of the tag of each category and the weight value corresponding to the tag of each category in each to-be-screened content includes:
performing a screening operation on the to-be-screened contents according to sorting of the to-be-screened contents in the content set.

Specifically, when the screening operation is performed, screening needs to performed according to sorting of the to-be-screened video manuscripts in the content set. For example, the content set has five video manuscripts sorted in descending order of scores: a video manuscript A, a video manuscript B, a video manuscript C, a video manuscript D, and a video manuscript E. In this case, when the screening operation is performed, screening is first performed on the video manuscript A. After the screening of the video manuscript A is completed, screening continues to be performed on the video manuscript B. Then, screening is sequentially performed on the video manuscript C, the video manuscript D, and the video manuscript E.

In this embodiment, the screening operation includes: obtaining a first weight value corresponding to a tag of each category in a current to-be-screened content; determining whether a first target distribution quota value corresponding to the tag of the category in the current to-be-screened content is greater than or equal to the first weight value; and if yes, using the current to-be-screened content as a target content, and updating the first target distribution quota value to a difference between the first target distribution quota value and the first weight value.

Specifically, when a current screening operation is performing screening on the video manuscript A, first weight values corresponding to a tag a and a tag b included in the video manuscript A may be first obtained. Assuming that the first weight values corresponding to the tag a and the tag b are respectively 0.5 and 0.5, after the first weight values corresponding to the tag a and the tag b are obtained, it may be determined whether a first target quota value corresponding to the tag a is greater than or equal to 0.5, and it may also be determined whether a first target quota value corresponding to the tag b is greater than or equal to 0.5. Assuming that the first target quota value corresponding to the tag a and the first target quota value corresponding to the tag b are respectively 4.0 and 3.5, the video manuscript A may be selected from the content set as a target content. In addition, the previous first target distribution quota values may be updated to differences between the first target distribution quota values and the first weight values, that is, the first target quota value corresponding to the tag a is updated to a difference: 4.0-0.5=3.5, and the first target quota value corresponding to the tag b is updated to a difference: 3.5-0.5=3.0.

After the screening operation of the video manuscript A is completed, screening continues to be sequentially performed on the video manuscript B, the video manuscript C, the video manuscript D, and the video manuscript E according to the foregoing manner.

In this embodiment of this application, the to-be-screened content set is obtained, where the content set includes the plurality of to-be-screened contents, each to-be-screened content has the identification information, the tag of the at least one category, and the score, and the plurality of to-be-screened contents are sorted in the content set in advance by using the scores; the distribution quota value of the tag that is of each category and that is included in the content set is calculated based on the tag of each category in each to-be-screened content and the weight value corresponding to the tag of each category; the target distribution quota value of the tag of each category is calculated based on each distribution quota value and the preset tag distribution quota adjustment function; and the target contents that meet the first preset condition are sequentially selected from the content set based on the target distribution quota value of the tag of each category and the weight value corresponding to the tag of each category in each to-be-screened content. In this embodiment of this application, when the contents in the to-be-screened content set are screened, for each to-be-screened content, it can be determined whether the current to-be-screened content is a target content by performing one time of traversal screening without needing to perform nested traversal. Therefore, this application can save a computing resource that needs to be consumed when the to-be-screened contents are screened, and can reduce time consumed when the to-be-screened contents are screened.

In an example implementation, when a quantity of selected target contents is less than a preset quantity, a target content that meets a second preset condition may continue to be selected from remaining to-be-screened contents in the content set, where the second preset condition is that a target distribution quota value corresponding to a tag of at least one category in a current to-be-screened content is not 0.

Specifically, the preset quantity is a preset quantity of target contents that need to be selected from the content set. For example, the content set has ten video manuscripts, and only four target contents are selected. In this case, a video manuscript whose target quota value corresponding to a tag of at least one category is not 0 is selected from remaining six video manuscripts in the content set as a target content.

For example, assuming that the remaining six video manuscripts are a video manuscript 1, a video manuscript 2, a video manuscript 3, a video manuscript 4, a video manuscript 5, and a video manuscript 6 in descending order of scores, a target quota value corresponding to a tag a in the video manuscript 1 is 0.2, a target quota value corresponding to a tag b in the video manuscript 2 is 0.3, a target quota value corresponding to the tag b in the video manuscript 3 is 0.4, and all target quota values corresponding to tags of all categories in the video manuscript 4, the video manuscript and the video manuscript 6 are 0, the video manuscript 1, the video manuscript 2, and the video manuscript 3 may be all used as target contents when the screening operation is performed. Certainly, if only one video manuscript currently needs to be further selected as a target content, only the video manuscript 1 with a largest score may be used as a target content; or if two video manuscripts currently need to be further selected as target contents, the video manuscript 1 and the video manuscript 2 whose scores are top ranked may be used as target contents.

In this embodiment, when the preset quantity of target contents are not selected, the target content that meets the second preset condition is selected from the remaining to-be-screened contents in the content set, thereby increasing a tag coverage ratio (a ratio of a quantity of tags appearing in a screening result set to a total quantity of tags in the original content set) of content screening.

In an example implementation, when a quantity of selected target contents is less than a preset quantity, a target content that meets a third preset condition may alternatively continue to be selected from remaining to-be-screened contents in the content set, where the third preset condition is that a current to-be-screened content has a preset mark.

Specifically, the preset mark is a mark for marking the to-be-screened video manuscript as a low-quality video manuscript. When a tag of the video manuscript is in relatively poor correlation with tags of other high-quality video manuscripts, such a video manuscript may be marked as a low-quality video manuscript.

In this embodiment, the low-quality video manuscript is selected as a target content, so that diversity of selected contents can be improved.

In an example implementation, when a quantity of selected target contents is less than a preset quantity, a target content that meets a fourth preset condition may alternatively continue to be selected from remaining to-be-screened contents in the content set, where the fourth preset condition is that a score of a current to-be-screened content is greater than scores of other to-be-screened contents.

Specifically, when the quantity of selected target contents is less than the preset quantity, a target content may be selected from the remaining to-be-screened video manuscripts in descending order of scores. For example, the remaining to-be-screened video manuscripts are the foregoing manuscript 1 to manuscript 6. In this case, when one video manuscript needs to be further selected as a target content, the video manuscript 1 may be selected as a target content. Similarly, if two video manuscripts further need to be selected as target contents, the video manuscript 1 and the video manuscript 2 may be selected as target contents.

In this embodiment, a video manuscript with a larger score is selected as a target content, so that a score priority ratio (a ratio at which a manuscript whose score is top ranked/that is top ranked in previous-round processing of current screening enters a screening result) can be increased.

In an example implementation, when a quantity of selected target contents is less than a preset quantity, a target content that meets a fifth preset condition may alternatively continue to be selected from remaining to-be-screened contents in the content set, where the fifth preset condition is that target distribution quota values corresponding to tags of all categories in a current to-be-screened content A are 0 but a total quantity of tags of each category in the current to-be-screened content A (assuming that the current to-be-screened content A includes a tags a and a tag b) does not exceed a preset threshold. For example, the preset threshold is 5. If all selected target contents include four tags a and three tags b, the current to-be-screened content A can be used as a target content; or if all selected target contents include five tags a and six tags b, the current to-be-screened content A cannot be used as a target content.

For example, to facilitate understanding of the technical solutions of this application, the following describes the technical solutions of this application with reference to a specific application scenario.

It is assumed that five video manuscripts need to be selected from ten video manuscripts as target contents, and details of the ten video manuscripts arranged in descending order of scores (Score) are shown in the following table:

| Id (identification information) | Tags (tags) | Score (score) |
|---|---|---|
| id_0 | tag_0, tag_1 | 0.95 |
| id_1 | tag_2, tag_3 | 0.9 |
| id_2 | tag_4, tag_5 | 0.85 |
| id_3 | tag_0, tag_2 | 0.8 |
| id_4 | tag_1, tag_4 | 0.75 |
| id_5 | tag_3, tag_5 | 0.7 |
| id_6 | tag_0, tag_6 | 0.65 |
| id_7 | tag_0, tag_7 | 0.6 |
| id_8 | tag_0, tag_6 | 0.55 |
| id_9 | tag_6, tag_7 | 0.5 |

If a total weight value 1 of each of the ten video manuscripts is equally divided among tags of all categories in the video manuscript, that is, a weight value of a tag of each category in each of the ten video manuscripts is 0.5, a quota value that is of a tag of each category and that is shown in the following table may be obtained through calculation based on the tag of each category in each to-be-screened content and the weight value corresponding to the tag of each category:

| Tag | Quota |
|---|---|
| tag_0 | 2.5 |
| tag_1 | 1 |
| tag_2 | 1 |
| tag_3 | 1 |
| tag_4 | 1 |
| tag_5 | 1 |
| tag_6 | 1.5 |
| tag_7 | 1 |

After the quota value of the tag of each category is obtained, assuming that each quota value is reduced by two times in an equal proportion by using a tag distribution quota adjustment function, each target quota value shown in the following table may be obtained:

| Tag | Target quota |
|---|---|
| tag_0 | 1.25 |
| tag_1 | 0.5 |
| tag_2 | 0.5 |
| tag_3 | 0.5 |
| tag_4 | 0.5 |
| tag_5 | 0.5 |
| tag_6 | 0.75 |
| tag_7 | 0.5 |

After each target quota value is obtained, a screening operation may be performed according to sorting of the video manuscripts in the ten video manuscripts. First, for a video manuscript of id_0, because the video manuscript includes tag_0 whose weight value is 0.5 and tag_1 whose weight value is 0.5, and the target quota values currently corresponding to tag_0 and tag_1 are both greater than 0.5, the video manuscript whose identification information is id_0 can be selected as a target content, and a difference between the target quota value 1.25 corresponding to tag_0 in id_0 and the weight value 0.5 corresponding to tag_0, that is, 1.25-0.5=0.75, can be used as an updated target quota value of tag_0. Similarly, a difference between the target quota value 0.5 corresponding to tag_1 in id_0 and the weight value 0.5 corresponding to tag_1, that is, 0.5-0.5=0, can be used as an updated target quota value of tag_1. Each target quota value shown in the following table may be obtained after the updating:

| Tag | Target quota |
|---|---|
| tag_0 | 0.75 |
| tag_1 | 0 |
| tag_2 | 0.5 |
| tag_3 | 0.5 |
| tag_4 | 0.5 |
| tag_5 | 0.5 |
| tag_6 | 0.75 |
| tag_7 | 0.5 |

Similarly, video manuscripts of id_1 and id_2 can be selected as target contents. After the screening operation is performed on the video manuscripts of id_1 and id_2, each target quota value shown in the following table may be obtained:

| Tag | Target quota |
|---|---|
| tag_0 | 0.75 |
| tag_1 | 0 |
| tag_2 | 0 |
| tag_3 | 0 |
| tag 4 | 0 |
| tag_5 | 0 |
| tag_6 | 0.75 |
| tag_7 | 0.5 |

Next, the screening operation is performed on a video manuscript of id_3. Because the video manuscript includes tag_0 whose weight value is 0.5 and tag_2 whose weight value is 0.5, and the target quota value currently corresponding to tag_2 is 0 and is less than 0.5, the video manuscript whose identification information is id_3 cannot be selected as a target content. Similarly, video manuscripts of id_4 and id_5 cannot be selected as target contents because of no enough target quota values.

Then, the screening operation is performed on a video manuscript of id_6. Because the video manuscript includes tag_0 whose weight value is 0.5 and tag_6 whose weight value is 0.5, and the target quota values currently corresponding to tag_0 and tag_6 are both greater than 0.5, the video manuscript whose identification information is id_6 can be selected as a target content, and a difference between the target quota value 0.75 corresponding to tag_0 in id_6 and the weight value 0.5 corresponding to tag_0, that is, 0.75-0.5=0.25, can be used as an updated target quota value of tag_0. Similarly, a difference between the target quota value 0.75 corresponding to tag_6 in id_6 and the weight value 0.5 corresponding to tag_6, that is, 0.75-0.5=0.25, can be used as an updated target quota value of tag_6. Each target quota value shown in the following table may be obtained after the updating:

| Tag | Target quota |
|---|---|
| tag_0 | 0.25 |
| tag_1 | 0 |
| tag_2 | 0 |
| tag_3 | 0 |
| tag_4 | 0 |
| tag_5 | 0 |
| tag_6 | 0.25 |
| tag_7 | 0.5 |

Finally, the screening operation is sequentially performed on video manuscripts of id_7, id_8, and id_9. The video manuscripts of id_7, id_8, and id_9 cannot be selected as target contents because of no enough target quota values.

Only the video manuscripts of {id_0, id_1, id_2, id_6} are selected as target contents after the screening operation of all the video manuscripts is completed, and a screening target is five video manuscripts. Therefore, in an implementation, a video manuscript whose target quota value corresponding to a tag of at least one category is not 0 is further selected from the remaining video manuscripts of id_3, id_4, id_5, id_7, id_8, and id_9 as a target content. In this embodiment, a target quota value corresponding to a tag of at least one category in each of the video manuscripts of id_3 and id_7 is not 0. However, because both the target quota values corresponding to the tags of the two categories in the video manuscript of id_7 are not 0, and a target quota value corresponding to a tag of only one category in the video manuscript of id_3 is not 0, to obtain a better tag distribution ratio, the video manuscript of id_7 can be selected as a target content.

In another implementation, a video manuscript whose score is greater than scores of other to-be-screened contents may be further selected from the remaining video manuscripts of id_3, id_4, id_5, id_7, id_8, and id_9. In this embodiment, because the score of the video manuscript of id_3 is the largest, the video manuscript of id_3 can be selected as a target content.

FIG. 5 is a program module diagram of an embodiment of a content screening apparatus 50 according to this application.

In this embodiment, the content screening apparatus 50 includes a series of computer-readable instructions stored in a memory. When the computer-readable instructions are executed by a processor, the content screening function in the embodiments of this application can be implemented. In some embodiments, the content screening apparatus 50 may be divided into one or more modules based on specific operations implemented by parts of the computer-readable instructions. For example, in FIG. 5, the content screening apparatus 50 may be divided into an obtaining module 51, a first calculation module 52, a second calculation module 53, and a screening module 54.

The obtaining module 51 is configured to obtain a to-be-screened content set, where the content set includes a plurality of to-be-screened contents, each to-be-screened content has identification information, a tag of at least one category, and a score, and the plurality of to-be-screened contents are sorted by scores in the content set in advance.

The first calculation module 52 is configured to calculate, based on a tag of each category in each to-be-screened content and a weight value corresponding to the tag of each category, a distribution quota value of a tag that is of each category and that is included in the content set.

In an example implementation, the first calculation module 52 is further configured to: obtain a weight value of a tag of a current category in each to-be-screened content, where the tag of the current category is a tag of a category in tags that are of all categories and that are included in the content set; and use a sum of all obtained weight values as a distribution quota value of the tag of the current category.

The second calculation module 53 is configured to calculate a target distribution quota value of the tag of each category based on each distribution quota value and a preset tag distribution quota adjustment function.

The screening module 54 is configured to sequentially select target contents that meet a first preset condition from the content set based on the target distribution quota value of the tag of each category and the weight value corresponding to the tag of each category in each to-be-screened content.

In an example implementation, the screening module 54 is further configured to perform a screening operation on the to-be-screened contents according to sorting of the to-be-screened contents in the content set, where the screening operation includes: obtaining a first weight value corresponding to a tag of each category in a current to-be-screened content; determining whether a first target distribution quota value corresponding to the tag of the category in the current to-be-screened content is greater than or equal to the first weight value; and if yes, using the current to-be-screened content as a target content, and updating the first target distribution quota value to a difference between the first target distribution quota value and the first weight value.

In an example implementation, the content screening apparatus 50 further includes a third calculation module.

The third calculation module is configured to calculate the weight value corresponding to the tag of each category in each to-be-screened content.

In an example implementation, the screening module 54 is further configured to: when a quantity of selected target contents is less than a preset quantity, select a target content that meets a second preset condition from remaining to-be-screened contents in the content set, where the second preset condition is that a target distribution quota value corresponding to a tag of at least one category in a current to-be-screened content is not 0.

In an example implementation, the screening module 54 is further configured to: when a quantity of selected target contents is less than a preset quantity, select a target content that meets a third preset condition from remaining to-be-screened contents in the content set, where the third preset condition is that a current to-be-screened content has a preset mark.

In an example implementation, the screening module 54 is further configured to: when a quantity of selected target contents is less than a preset quantity, select a target content that meets a fourth preset condition from remaining to-be-screened contents in the content set, where the fourth preset condition is that a score of a current to-be-screened content is greater than scores of other to-be-screened contents.

In this embodiment of this application, the to-be-screened content set is obtained, where the content set includes the plurality of to-be-screened contents, each to-be-screened content has the identification information, the tag of the at least one category, and the score, and the plurality of to-be-screened contents are sorted in the content set in advance by using the scores; the distribution quota value of the tag that is of each category and that is included in the content set is calculated based on the tag of each category in each to-be-screened content and the weight value corresponding to the tag of each category; the target distribution quota value of the tag of each category is calculated based on each distribution quota value and the preset tag distribution quota adjustment function; and the target contents that meet the first preset condition are sequentially selected from the content set based on the target distribution quota value of the tag of each category and the weight value corresponding to the tag of each category in each to-be-screened content. In this embodiment of this application, when the contents in the to-be-screened content set are screened, for each to-be-screened content, it can be determined whether the current to-be-screened content is a target content by performing one time of traversal screening without needing to perform nested traversal. Therefore, this application can save a computing resource that needs to be consumed when the to-be-screened contents are screened, and can reduce time consumed when the to-be-screened contents are screened.

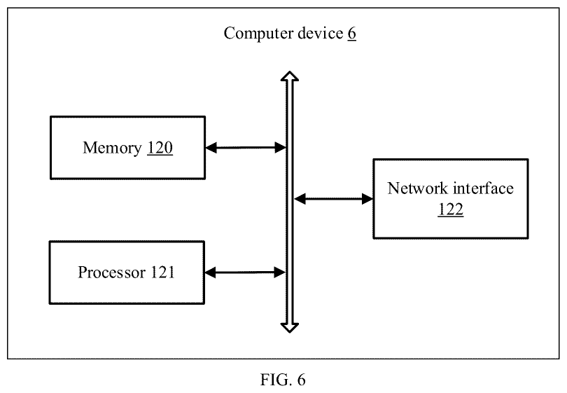

FIG. 6 is a schematic diagram of a hardware structure of a computer device 6 suitable for implementing a content screening method according to an embodiment of this application. In this embodiment, the computer device 6 is a device that can automatically perform value calculation and/or information processing based on an instruction that is set or stored in advance. For example, the computer device 6 may be a tablet computer, a notebook computer, a desktop computer, a rack server, a blade server, a tower server, or a cabinet server (including an independent server, or a server cluster including a plurality of servers). As shown in FIG. 6, the computer device 6 includes at least but is not limited to a memory 120, a processor 121, and a network interface 122 that can be communicatively linked with each other by using a system bus.

The memory 120 includes at least one type of computer-readable storage medium. The computer-readable storage medium may be volatile or nonvolatile. The computer-readable storage medium includes a flash memory, a hard disk, a multimedia card, a card-type memory (such as an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 120 may be an internal storage module of the computer device 6, such as a hard disk or a memory of the computer device 6. In some other embodiments, the memory 120 may be an external storage device of the computer device 6, such as a plug-in hard disk, a smart media card (SMC), a secure digital (SD) card, or a flash card (Flash Card) that is equipped with the computer device 6. Certainly, the memory 120 may alternatively include both an internal storage module and an external storage device of the computer device 6. In this embodiment, the memory 120 is usually configured to store an operating system and various types of application software that are installed in the computer device 6, such as program code of the content screening method. In addition, the memory 120 may be further configured to temporarily store various types of data that has been output or is to be output.

In some embodiments, the processor 121 may be a central processing unit (CPU), a controller, a microcontroller, a microprocessor, or another data processing chip. The processor 121 is usually configured to control overall operations of the computer device 6, for example, perform control and processing correlated with data interaction and communication with the computer device 6. In this embodiment, the processor 121 is configured to run program code stored in the memory 120 or process data.

The network interface 122 may include a wireless network interface or a wired network interface, and the network interface 122 is usually configured to establish a communication link between the computer device 6 and another computer device. For example, the network interface 122 is configured to connect the computer device 6 to an external terminal by using a network, to establish a data transmission channel and a communication link between the computer device 6 and the external terminal. The network may be a wireless or wired network such as an intranet (Intranet), the Internet (Internet), a global system for mobile communications (GSM), wideband code division multiple access (WCDMA), a 4G network, a 5G network, Bluetooth (Bluetooth), or Wi-Fi.

It should be noted that FIG. 6 shows only the computer device having the components 120 to 122. However, it should be understood that implementation of all the shown components is not required, and more or fewer components may be alternatively implemented.

In this embodiment, the content screening method stored in the memory 120 may be divided into one or more program modules and executed by one or more processors (the processor 121 in this embodiment) to complete this application.

An embodiment of this application provides a computer-readable storage medium. The computer-readable storage medium stores computer-readable instructions, and the following steps are implemented when the computer-readable instructions are executed by a processor:
obtaining a to-be-screened content set, where the content set includes a plurality of to-be-screened contents, each to-be-screened content has identification information, a tag of at least one category, and a score, and the plurality of to-be-screened contents are sorted by scores in the content set in advance;
calculating, based on a tag of each category in each to-be-screened content and a weight value corresponding to the tag of each category, a distribution quota value of a tag that is of each category and that is included in the content set;
calculating a target distribution quota value of the tag of each category based on each distribution quota value and a preset tag distribution quota adjustment function; and
sequentially selecting target contents that meet a first preset condition from the content set based on the target distribution quota value of the tag of each category and the weight value corresponding to the tag of each category in each to-be-screened content.

In this embodiment, the computer-readable storage medium includes a flash memory, a hard disk, a multimedia card, a card-type memory (such as an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, such as a hard disk or a memory of the computer device. In some other embodiments, the computer-readable storage medium may be an external storage device of a computer device, such as a plug-in hard disk, a smart media card (SMC), a secure digital (SD) card, or a flash card (Flash Card) that is equipped with the computer device. Certainly, the computer-readable storage medium may alternatively include both an internal storage unit and an external storage device of a computer device. In this embodiment, the computer-readable storage medium is usually configured to store an operating system and various types of application software that are installed in the computer device, such as program code of the content screening method in the embodiments. In addition, the computer-readable storage medium may be further configured to temporarily store various types of data that has been output or is to be output.

The apparatus embodiments described above are merely examples. Units described as separate components may or may not be physically separated, and components displayed as units may or may not be physical units, that is, the components may be located in one place, or may be distributed to at least two network units. Some or all of the modules may be selected based on an actual need to achieve the objective of the solutions of the embodiments of this application. Those of ordinary skill in the art can understand and implement this application without creative efforts.

Through description of the foregoing implementations, those of ordinary skill in the art can clearly understand that the implementations may be implemented by using software and a universal hardware platform, or certainly, may be implemented by using hardware. Those of ordinary skill in the art can understand that all or some of the processes in the methods in the foregoing embodiments may be implemented by instructing related hardware by using computer-readable instructions. The program may be stored in a computer-readable storage medium. The processes of the embodiments of the methods may be performed when the program is executed. The storage medium may be a magnetic disk, an optical disc, a read-only memory (ROM), a random access memory (RAM), or the like.

Finally, it should be noted that the foregoing embodiments are merely intended for describing, instead of limiting, the technical solutions of this application. Although this application is described in detail with reference to the foregoing embodiments, those of ordinary skill in the art should understand that they can still make modifications to the technical solutions described in the foregoing embodiments or make equivalent replacements to some or all technical features thereof. These modifications or replacements do not make the essence of the corresponding technical solutions depart from the scope of the technical solutions of the embodiments of this application.

1. A computer-implemented method of recommending content while saving computer resources, comprising:
obtaining a content set to be screened, wherein the content set comprises a plurality of to-be-screened contents, wherein each to-be-screened content is associated with identification information, at least one tag indicative of at least one category, and a score, and wherein the plurality of to-be-screened contents are ranked based on their respective scores in the content set in advance;
computing a distribution quota value of each category indicated by a corresponding tag and associated with the plurality of to-be-screened contents in the content set based on the at least one category associated with each to-be-screened content and a weight value corresponding to the at least one category associated with each to-be-screened content;
computing a target distribution quota value of each category indicated by a corresponding tag based on the distribution quota value of each category and a preset tag distribution quota adjustment function;
sequentially selecting target contents that meet a first preset condition from the content set based on the target distribution quota value of each category and the weight value corresponding to the at least one category associated with each to-be-screened content; and
recommending the selected target contents to a user associated with a client computing device.

2. The computer-implemented method according to claim 1, wherein the computing a distribution quota value of each category indicated by a corresponding tag and associated with the plurality of to-be-screened contents in the content set based on the at least one category associated with each to-be-screened content and a weight value corresponding to the at least one category associated with each to-be-screened content comprises:
obtaining a weight value corresponding to a current category associated with each of the plurality of to-be-screened content, wherein the current category is one of a plurality of categories indicated by a plurality of tags associated with the plurality of to-be-screened contents in the content set; and
determining a sum of all obtained weight values as a distribution quota value of the current category.

3. The computer-implemented method according to claim 1, wherein the sequentially selecting target contents that meet a first preset condition from the content set based on the target distribution quota value of each category and the weight value corresponding to the at least one category associated with each to-be-screened content comprises:
performing a screening operation on the plurality of to-be-screened contents based on a rank order of the plurality of to-be-screened contents in the content set, wherein the screening operation comprises:
obtaining a first weight value corresponding to each category indicated by a corresponding tag and associated with a current to-be-screened content;
determining whether a first target distribution quota value corresponding to each category associated with the current to-be-screened content is greater than or equal to the first weight value;
identifying the current to-be-screened content as a target content in response to a determination that the first target distribution quota value is greater than or equal to the first weight value; and
updating the first target distribution quota value based on a difference between the first target distribution quota value and the first weight value in response to the determination that the first target distribution quota value is greater than or equal to the first weight value.

4. The computer-implemented method according to claim 1, further comprising:
when a quantity of the selected target contents is less than a preset quantity, selecting a target content from remaining to-be-screened contents in the content set based on a second preset condition, wherein the second preset condition indicates that a target distribution quota value corresponding to at least one category associated with a to-be-screened content among the remaining to-be-screened contents is not zero.

5. The computer-implemented method according to claim 1, further comprising:
when a quantity of the selected target contents is less than a preset quantity, selecting a target content from remaining to-be-screened contents in the content set based on a third preset condition, wherein the third preset condition indicates that a to-be-screened content among the remaining to-be-screened contents has a preset mark.

6. The computer-implemented method according to claim 1, further comprising:
when a quantity of the selected target contents is less than a preset quantity, selecting a target content from remaining to-be-screened contents in the content set based on a fourth preset condition, wherein the fourth preset condition indicates that a score of a to-be-screened content is greater than scores of other to-be-screened contents among the remaining to-be-screened contents.

7. The computer-implemented method according to claim 1, wherein before the computing a distribution quota value of each category indicated by a corresponding tag and associated with the plurality of to-be-screened contents in the content set based on the at least one category associated with each to-be-screened content and a weight value corresponding to the at least one category associated with each to-be-screened content, the content screening method further comprises:
computing a weight value corresponding to each of categories associated with each to-be-screened content.

8. (canceled)

9. A computing system, wherein the computing system comprises a memory, a processor, and computer-readable instructions that are stored in the memory and executable by the processor, and wherein when the processor executes the computer-readable instructions, the processor implements operations comprising:
obtaining a content set to be screened, wherein the content set comprises a plurality of to-be-screened contents, wherein each to-be-screened content is associated with identification information, at least one tag indicative of at least one category, and a score, and wherein the plurality of to-be-screened contents are ranked based on their respective scores in the content set in advance;
computing a distribution quota value of each category indicated by a corresponding tag and associated with the plurality of to-be-screened contents in the content set based on the at least one category associated with each to-be-screened content and a weight value corresponding to the at least one category associated with each to-be-screened content;
computing a target distribution quota value of each category indicated by a corresponding tag based on the distribution quota value of each category and a preset tag distribution quota adjustment function;
sequentially selecting target contents that meet a first preset condition from the content set based on the target distribution quota value of each category and the weight value corresponding to the at least one category associated with each to-be-screened content; and
recommending the selected target contents to a user associated with a client computing device.

10. The computing system according to claim 9, wherein the computing a distribution quota value of each category indicated by a corresponding tag and associated with the plurality of to-be-screened contents in the content set based on the at least one category associated with each to-be-screened content and a weight value corresponding to the at least one category associated with each to-be-screened content comprises:
obtaining a weight value corresponding to a current category associated with each of the plurality of to-be-screened content, wherein the current category is one of a plurality of categories indicated by a plurality of tags associated with the plurality of to-be-screened contents in the content set; and
determining a sum of all obtained weight values as a distribution quota value of the current category.

11. The computing system according to claim 9, wherein the sequentially selecting target contents that meet a first preset condition from the content set based on the target distribution quota value of each category and the weight value corresponding to the at least one category associated with each to-be-screened content comprises:
performing a screening operation on the plurality of to-be-screened contents based on a rank order of the plurality of to-be-screened contents in the content set, wherein the screening operation comprises:
obtaining a first weight value corresponding to each category indicated by a corresponding tag and associated with a current to-be-screened content;
determining whether a first target distribution quota value corresponding to each category associated with the current to-be-screened content is greater than or equal to the first weight value;
identifying the current to-be-screened content as a target content in response to a determination that the first target distribution quota value is greater than or equal to the first weight value; and
updating the first target distribution quota value based on a difference between the first target distribution quota value and the first weight value in response to the determination that the first target distribution quota value is greater than or equal to the first weight value.

12. The computing system according to claim 9, the operations further comprising:
when a quantity of the selected target contents is less than a preset quantity, selecting a target content from remaining to-be-screened contents in the content set based on a second preset condition, wherein the second preset condition indicates that a target distribution quota value corresponding to at least one category associated with a to-be-screened content among the remaining to-be-screened contents is not zero.

13. The computing system according to claim 9, the operations further comprising:
when a quantity of the selected target contents is less than a preset quantity, selecting a target content from remaining to-be-screened contents in the content set based on a third preset condition, wherein the third preset condition indicates that a to-be-screened content among the remaining to-be-screened contents has a preset mark.

14. The computing system according to claim 9, the operations further comprising:
when a quantity of the selected target contents is less than a preset quantity, selecting a target content from remaining to-be-screened contents in the content set based on a fourth preset condition, wherein the fourth preset condition indicates that a score of a to-be-screened content is greater than scores of other to-be-screened contents among the remaining to-be-screened contents.

15. A non-transitory computer-readable storage medium, wherein the computer-readable storage medium stores computer-readable instructions, and wherein when the computer-readable instructions are executed by a processor, the processor implement operations comprising:
obtaining a content set to be screened, wherein the content set comprises a plurality of to-be-screened contents, wherein each to-be-screened content is associated with identification information, at least one tag indicative of at least one category, and a score, and wherein the plurality of to-be-screened contents are ranked based on their respective scores in the content set in advance;
computing a distribution quota value of each category indicated by a corresponding tag and associated with the plurality of to-be-screened contents in the content set based on the at least one category associated with each to-be-screened content and a weight value corresponding to the at least one category associated with each to-be-screened content;
computing a target distribution quota value of each category indicated by a corresponding tag based on the distribution quota value of each category and a preset tag distribution quota adjustment function;
sequentially selecting target contents that meet a first preset condition from the content set based on the target distribution quota value of each category and the weight value corresponding to the at least one category associated with each to-be-screened content; and
recommending the selected target contents to a user associated with a client computing device.

16. The non-transitory computer-readable storage medium according to claim 15, wherein the computing a distribution quota value of each category indicated by a corresponding tag and associated with the plurality of to-be-screened contents in the content set based on the at least one category associated with each to-be-screened content and a weight value corresponding to the at least one category associated with each to-be-screened content comprises:
obtaining a weight value corresponding to a current category associated with each of the plurality of to-be-screened content, wherein the current category is one of a plurality of categories indicated by a plurality of tags associated with the plurality of to-be-screened contents in the content set; and
determining a sum of all obtained weight values as a distribution quota value of the current category.

17. The non-transitory computer-readable storage medium according to claim 15, wherein the sequentially selecting target contents that meet a first preset condition from the content set based on the target distribution quota value of each category and the weight value corresponding to the at least one category associated with each to-be-screened content comprises:
performing a screening operation on the plurality of to-be-screened contents based on a rank order of the plurality of to-be-screened contents in the content set, wherein the screening operation comprises:
obtaining a first weight value corresponding to each category indicated by a corresponding tag and associated with a current to-be-screened content;
determining whether a first target distribution quota value corresponding to each category associated with the current to-be-screened content is greater than or equal to the first weight value;
identifying the current to-be-screened content as a target content in response to a determination that the first target distribution quota value is greater than or equal to the first weight value; and
updating the first target distribution quota value based on a difference between the first target distribution quota value and the first weight value in response to the determination that the first target distribution quota value is greater than or equal to the first weight value.

18. The non-transitory computer-readable storage medium according to claim 15, the operations further comprising:
when a quantity of the selected target contents is less than a preset quantity, selecting a target content from remaining to-be-screened contents in the content set based on a second preset condition, wherein the second preset condition indicates that a target distribution quota value corresponding to at least one category associated with a to-be-screened content among the remaining to-be-screened contents is not zero.

19. The non-transitory computer-readable storage medium according to claim 15, the operations further comprising:
when a quantity of the selected target contents is less than a preset quantity, selecting a target content from remaining to-be-screened contents in the content set based on a third preset condition, wherein the third preset condition indicates that a to-be-screened content among the remaining to-be-screened contents has a preset mark.

20. The non-transitory computer-readable storage medium according to claim 15, the operations further comprising:
when a quantity of the selected target contents is less than a preset quantity, selecting a target content from remaining to-be-screened contents in the content set based on a fourth preset condition, wherein the fourth preset condition indicates that a score of a to-be-screened content is greater than scores of other to-be-screened contents among the remaining to-be-screened contents.
